(19) United States
(12) Patent Application Publication
(10) Pub. No.: US 2014/0014224 A1
(43) Pub. Date: Jan. 16, 2014

(54) METHOD AND FILLING MACHINE FOR THE OPEN JET FILLING OF BOTTLES OR SIMILAR CONTAINERS

(71) Applicant: Jürgen Vorwerk, Morsdorf (DE)

(72) Inventor: Jürgen Vorwerk, Morsdorf (DE)

(21) Appl. No.: 14/009,541

(22) PCT Filed: Mar. 2, 2012
(86) PCT No.: PCT/EP12/00912

§ 371 Date: Oct. 3, 2013

(30) Foreign Application Priority Data
Apr. 12, 2011 (DE) 102011016760.9

(51) Int. Cl. B67C 3/04

(52) U.S. Cl. CPC B67C 3/04
USPC 141/1; 141/34

(57) ABSTRACT

A method for open jet filling of containers with liquid content using a machine having a rotor that rotates around a machine axis. The rotor carries filling stations, each having va filling element, each having an opening and a container carrier. The carrier holds a container such that its opening is at a selected distance from the dispensing opening. Contents dispensed in a controlled manner by the filling element flow in an open filling jet directed toward the container opening. The method includes compensating for deflection of the filling jet due to centrifugal force acting on it when the rotor rotates by causing controlled relative movement between the filling element and the container. As a result of this movement, the open jet cleanly enters the container through the container opening.

### RELATED APPLICATIONS

This application is the national stage entry, under 35 USC 371, of PCT application PCT/EP2012/000912, filed on Mar. 2, 2012, which, under 35 USC 119, claims the benefit of the priority date of German patent application DE 102011016760.9, filed on Apr. 12, 2011. The contents of the foregoing applications are incorporated herein by reference.

### FIELD OF INVENTION

The invention concerns a method and apparatus for open jet filling.

### BACKGROUND

The open jet filling of bottles or containers is known.

A certain drawback with open jet filling consists of the fact that, with the rotor of the filling machine rotating, due to the centrifugal force exerted on the open filling jet, the filling jet is deflected outwards in relation to the machine axis, i.e. away from this machine axis. This deflection, which in particular is particularly marked where the rotor diameter is small and/or where the rotor speed is high, has, to date, been taken into account when selecting the diameter of the open filling jet. It has also been taken into account when selecting the diameter of the container opening or container mouth of the containers to be filled to ensure that, despite the deflection due to centrifugal force, the filling jet completely enters the container to be filled through the particular container opening. This avoids content losses and dirtying of the outsides of the containers. The diameter of the filling jet thus cannot be optimally adjusted for the diameter of the container opening. Instead the diameter of the filling jet has, to date, always had to be selected to be clearly smaller than the diameter of the container opening. This has led to a reduction in or restriction on the performance (i.e. the number of containers filled per unit of time) of the relevant filling machine.

### SUMMARY The invention avoids the foregoing drawback and, inter alia, allows an improvement in the performance of a filling machine.

Due to the compensation for centrifugal force, inter alia an increase in the filling volume: unit of time ratio by the better utilization of the diameter of the container openings and thus the performance of the filling machine concerned is achieved, this being over the entire speed range of this machine. Alternatively, for the same performance of a filling machine, a clear reduction in the number of filling positions needed is possible.

The compensation for centrifugal force occurs basically by a controlled relative movement between the filling element of the particular filling station or the part of the filling element with the dispensing opening and the container, for example, due to the filling element being able to be rotated or swiveled in a controlled manner by at least an axis oriented tangentially to the direction of rotation of the rotor and thus perpendicular to the action of the centrifugal force. With an increasing speed of rotation of the rotor and increasing centrifugal force, the dispensing opening of the filling element is tilted towards the machine axis. The exit speed of the filling jet when leaving the dispensing opening thus counters the centrifugal force. The angle of tilt is adapted in a controlled manner according to the particular centrifugal force so that the open filling jet in the area of the container opening once again hits the latter centrically or substantially centrically.

The compensation for centrifugal force and the corresponding shift of the filling element and/or the container carrier is carried out for example by at least one actuator or servo drive provided independently for each filling station, but preferably by an actuator installation that is provided jointly for all the filling stations of the filling machine, this being in the angle range (dead angle), not used for filling, of the rotary movement of the rotor between the container outlet and the container inlet. By means, for example, by clamping means, the setting made to compensate for centrifugal force is then fixed until the corresponding filling station once again reaches the dead angle.

In the meaning of the invention, the expression “substantially” means deviations from exact values in each case by +/−10%, and preferably by +/−5% and/or deviations in the form of changes not significant for functioning.

Further developments, benefits and application possibilities of the invention arise also from the following description of examples of embodiments and from the figures. In this regard, all characteristics described and/or illustrated individually or in any combination are categorically the subject of the invention, regardless of their inclusion in the claims or reference to them. The content of the claims is also an integral part of the description.

### BRIEF DESCRIPTION OF THE DRAWINGS

The invention is explained in more detail below by means of the figures. The following are shown:

FIG. 1 shows a filling station with a filling element of a filling machine of a circulating design for the open jet filling of containers in the form of bottles, in a view tangential to the path of movement of the filling element around a vertical machine axis MA;

FIG. 2 shows a view of the filling station in FIG. 1 in a radial view relative to the machine axis MA;

FIGS. 3 and 4 show views along the lines set forth in FIGS. 1 and 2 for a further embodiment of the invention.

### DETAILED DESCRIPTION

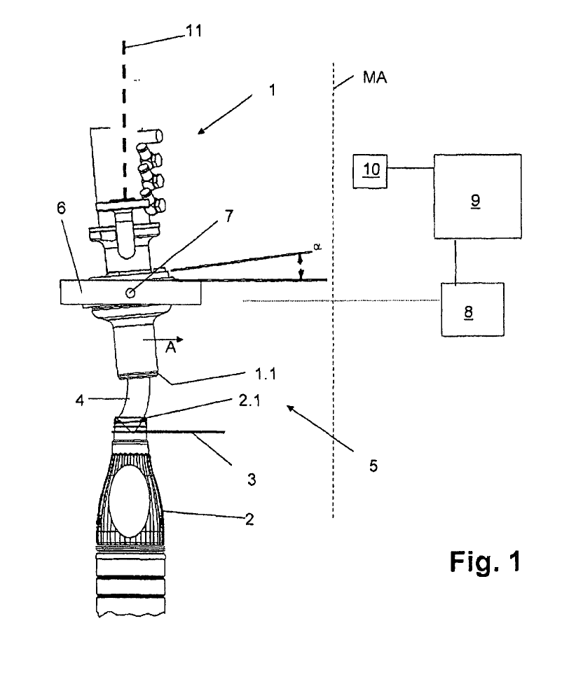

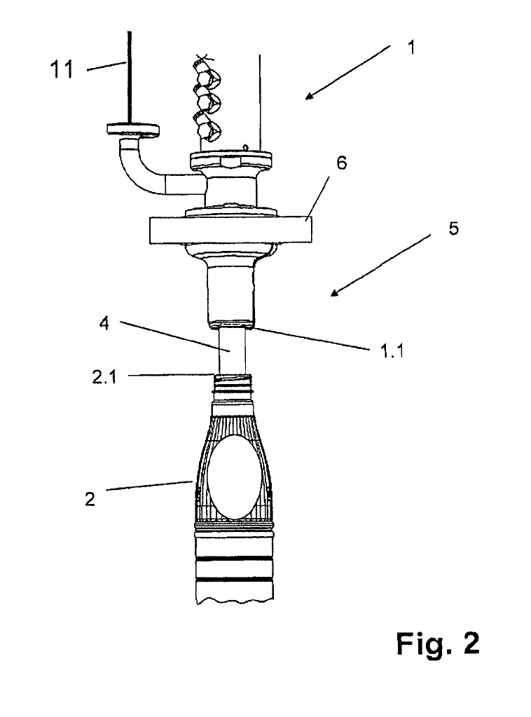

FIGS. 1 and 2 shows a filling element 1 of a filling machine of a circulating design for the open jet filling of containers in the form of bottles 2 with liquid contents. The latter are held suspended from a container carrier 3, this being such that the particular bottle 2, with its bottle axis in a vertical direction and parallel to a machine axis MA of the filling machine, is oriented with its bottle mouth or opening 2.1 beneath the filling element 1 and is at a distance from this filling element 1 or from a dispensing opening 1.1 formed at the bottom end of the filling element, such that during the filling, the contents are introduced in a controlled way as an open filling jet 4 through the bottle opening 2.1 into the bottle 2. The filling element 1 and the container carrier 3 form a filling position 5 that is arranged with a plurality of similar filling positions 5 on the circumference of a rotor 5 that has at least the vessel, not illustrated, that during filling is filled with the contents, is connected to the filling element 1, and is driven around the machine axis MA during filling.

To achieve the highest possible performance of the filling machine (number of bottles 2 filled per unit of time), a highest possible speed for the rotor 6 and also the biggest possible diameter of the open filling jet 4 is sought. Due to the centrifugal force generated by the rotary movement of the rotor 6, inter alia, the filling jet 4 is deflected increasingly radially outwards with increasing distance from the filling element 1, i.e. away from the machine axis. However, to ensure that the filling jet 4 enters the bottle opening 2.1 completely and centrically or substantially centrically, to compensate the deflection of the jet of contents 4, or to compensate for centrifugal force, a controlled movement is made at least of the bottom end of the filling element 1 containing the dispensing opening 1.1 radially inwards in relation to the machine axis MA, and indeed in the embodiment shown in FIGS. 1 and 2, by controlled swiveling or tipping of the filling element 1 by a swivel axis 7 disposed above the dispensing opening tangentially to the direction of rotation of rotor 6, this being by an angle α. The swiveling of the filling element 1 is effected by an actuator installation 8 that, for its part, is controlled by control and analysis electronics, for example by the control computer 9 of the filling machine, this being, in particular, dependent on the speed of the rotor 6. The angle of swivel α is here a function of the speed of rotor 6 such that this angle increases with increasing speed of rotation and, because of this, the radial distance of the dispensing opening of the filling element 1 from the machine axis decreases with increasing speed of the rotor 6. With the help of at least one sensor 10 connected to the control computer 9, the speed of the rotor 5 is captured. Furthermore, to compensate for centrifugal force, other parameters are also preferably taken into account, such as, inter alia, the shape and size of the particular bottle 2 and thus the distance of the bottle opening 2.1 from the underside of the filling element or the dispensing opening 1.1 there, the type of contents etc.

In an advantageous variant, not illustrated in more detail, the product can be supplied to the filling valve or the filling element by means of the swivel axis 7. The advantage lies in the fact that, with a solution of this kind, no flexible or movable product pipes are needed. The swivel axis 7 can here be embodied in a similar way as the rotary opening for fluids, which is known to the person skilled in the art, by the central media feed of rotating filling machines.

As, during the course of the filling operation, a constant or substantially constant speed of rotor 6 is to be assumed, the deflection of the jet of contents 4 is basically not tangential to the rotary movement of rotor 6, as is illustrated in FIG. 2.

The actuator installation 8 can be made in a different way, for example in the form of one or more actuators. In particular, the actuator installation 8 can be embodied such that in the angle area, not used for filling, of the rotary movement of the rotor 6 between the container outlet, at which the filled bottles 2 are removed from the filling stations 5, and the container inlet at which the empty bottles are each passed on to a filling station 5, the setting of the angle of tilt α of the filling elements 1 occurs for example by a control cam and then the relevant setting of each filling element 1 is locked or fixed until this filling element 1 with the circulating rotor 6 once again has reached the angle range not used for filling, whereupon, if applicable, a different setting or a correction of the angle of tilt α is carried out.

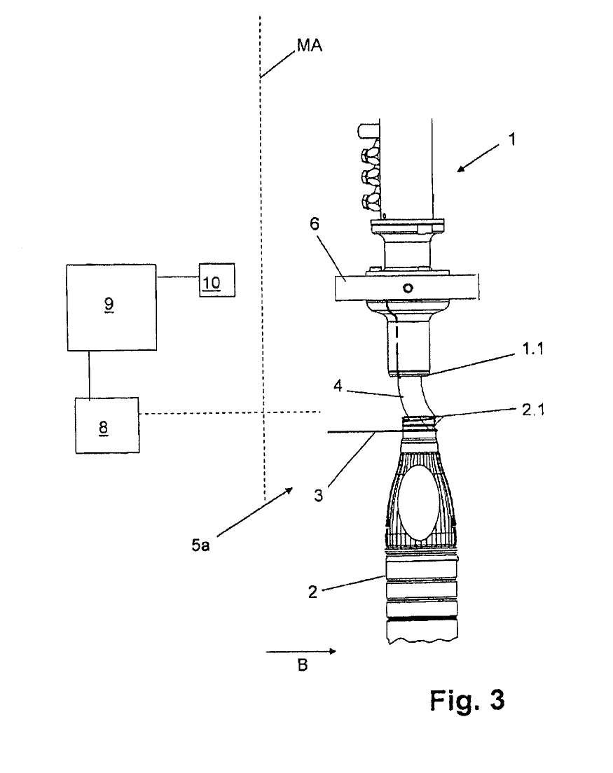

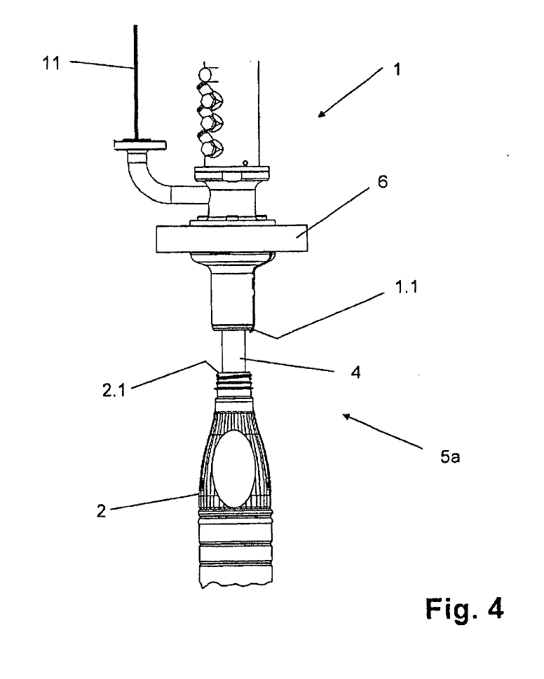

FIGS. 3 and 4 show, as a further embodiment, a filling station 5a that is in turn provided with a plurality of similar filling stations on the circumference of the rotor 6 driven in circulation around the vertical machine axis MA during the filling. The compensation for centrifugal force compensation, i.e. the compensation for the deflection of the open jet of contents 4 due to centrifugal force, occurs in this embodiment by a controlled movement of the container carrier 3 and thus the bottle 2 held on it radially outwards relative to the machine axis MA (arrow B in FIG. 3), this being with the actuator installation 8 and again at least depending on the speed of the rotor 6 and controlled by the control computer 9 of the filling machine.

The invention was described above using examples of embodiments. It is clear that modifications and variations are possible without thereby departing from the inventive idea underlying the invention.

Thus, it is assumed above that to compensate for the deflection of the open filling jet 4 by centrifugal forces, the filling element 1 or the part of this filling element having the dispensing opening, is moved radially inwards relative to the bottle opening 2.1 in relation to the machine axis MA, this being, in the case of the embodiment of FIGS. 1 and 2, by swiveling, or the relevant bottle 2 being moved radially outwards relative to the filling element 1 in relation to the machine axis MA. Other movements too of the particular filling element 1 and/or the relevant bottle 2 are possible to compensate for centrifugal force. For example, if the filling element 1 is not moved to compensate for centrifugal force, a swivel movement of container carrier 3 and thus the bottle 2 held on it, around at least one axis tangentially to the direction of rotation of the rotor 6 can be carried out. This swivel movement then occurs preferably in a controlled manner such that the open jet of contents 4 not only enters the bottle 2 completely through the bottle opening 2.1, but also, the axis that the open jet of contents 4 has at the bottle opening 2.1, is at the same time the bottle axis. This situation can basically also be achieved by a corresponding controlled movement of the particular filling element 1 relative to the bottle 2.

### Reference Drawing List

1 Filling element
1.1 Dispensing opening of the filling element
2 Bottle
2.1 Bottle opening
3 Container carrier
4 Open jet of contents
5, 5a Filling station
6 Rotor
7 Swivel axis
8 Actuator installation
9 Control computer
10 Sensor
A Swivel movement of the filling element to compensate for centrifugal force
B Shift movement of the bottle or the container carrier 3 to compensate for centrifugal force

1-7. (canceled)

8. A method for open jet filling of containers with liquid content using a filling machine having a rotor that rotates around a vertical machine axis, wherein said rotor carries filling stations, wherein each filling station comprises a filling element, wherein each filling element comprises a dispensing opening and a container carrier, wherein said container carrier holds a container such that a container opening of said container is disposed at a selected distance from said dispensing opening of said corresponding filling element so that contents dispensed in a controlled manner by said filling element flow in an open filling jet directed toward said container opening, said method comprising compensating for a deflection of said filling jet due to centrifugal force acting on said filling jet when said rotor rotates, wherein compensating for said deflection of said filling jet due to centrifugal force comprises causing a controlled relative movement between said filling element and said container, wherein, as a result of said controlled relative movement, said open jet enters said container completely and said open jet is centered within said container opening.

9. The method of claim 8, wherein causing a controlled relative movement comprises moving one of said filling element and said dispensing opening radially toward said machine axis in a manner that depends on speed of said rotor.

10. The method of claim 9, wherein moving one of said filling element and said dispensing opening radially toward said machine axis in a manner that depends on speed of said rotor comprises causing radial movement of said filling element.

11. The method of claim 9, wherein moving one of said filling element and said dispensing opening radially toward said machine axis in a manner that depends on speed of said rotor comprises swiveling said filling element around a swivel axis, wherein said swivel axis is oriented tangentially to a direction of rotation of said rotor, and wherein said swivel axis is disposed above said dispensing opening.

12. The method of claim 8, wherein causing a controlled relative movement between said filling element and said container comprises moving one of said filling element and said dispensing opening radially toward said machine axis in a manner that depends on speed of said rotor and that causes a radial distance between said dispensing opening and said machine axis to decrease as rotor speed increases.

13. The method of claim 8, wherein causing a controlled relative movement comprises moving said container radially toward said machine axis in a manner that depends on speed of said rotor.

14. The method of claim 13, wherein moving said container radially toward said machine axis in a manner that depends on speed of said rotor comprises causing radial movement of said container such that a radial distance between said machine axis and said container increase when rotor speed increases.

15. The method of claim 13, wherein moving said container radially toward said machine axis in a manner that depends on speed of said rotor comprises swiveling said container around a swivel axis, wherein said swivel axis is oriented tangentially to a direction of rotation of said rotor, and wherein said swivel axis is disposed above said dispensing opening such that a swivel angle increases as rotor speed increases.

16. The method of claim 8, wherein causing a controlled relative movement between said filling element and said container comprises, based on a speed of said rotor, causing controlled relative movement that causes an axial direction of said open filling jet, upon entry into said container, to be oriented parallel to an axis of said container opening.

17. An apparatus for open jet filling of containers, said apparatus comprising a circulating filling machine, said circulating filling machine comprising a rotor that rotates around a vertical machine axis, and a plurality of filling stations provided on said rotor, each of said filling stations comprising a filling element, and a container carrier for holding a container with a container opening thereof at a selected distance under a dispensing opening of said filling element so that contents dispensed in a controlled manner by said filling element flow in an open filling jet during filling of said container, said filling machine further comprising an actuator configured to compensate for deflection of said open filling jet caused by centrifugal forces due to the rotation of said rotor wherein said actuator causes a structure to engage in a controlled movement in a radial direction relative to said machine axis, said movement being dependent on a speed of said rotor, wherein said structure is selected from the group consisting of a filling element and a container carrier holding a container, wherein said controlled movement results in one of a change in a distance between said structure and said machine axis as a result of movement of said structure in a radial direction, and a change in a distance between a portion of said structure and said machine axis as a result of swiveling of said structure around a swivel axis that is oriented tangentially to a direction of rotation of said rotor.

18. The apparatus of claim 17, further comprising a pipe connecting said filling elements to a source of fluid.

19. The apparatus of claim 17, wherein said pipe is a flexible and telescopic pipe.

20. The apparatus of claim 19, wherein said pipe is a U-shaped pipe.

21. The apparatus of claim 19, wherein said pipe is a S-shaped pipe.

22. The apparatus of claim 17, wherein said actuator is common to all filling elements on said rotor.

23. The apparatus of claim 17, further comprising an actuation installation for setting centrifugal force compensation of at least one of said filling elements and said container carriers, wherein said actuation installation is common to at least one of all filling elements and all container carriers of said filling machine that are within an angular range of rotational movement of said rotor, said angular range being between a container outlet and a container inlet, wherein said angular range is not used for container filling, wherein said actuation installation performs compensation for centrifugal force, wherein said filling stations comprise means for fixing or locking a relevant setting of centrifugal force compensation at a filling station until said filling station is carried by said rotor to said angular range.
